(19) United States
(12) Patent Application Publication
(10) Pub. No.: US 2025/0287310 A1
(43) Pub. Date: Sep. 11, 2025

(54) APPARATUS AND METHOD FOR MONITORING RADIO RESOURCE IN MULTI-NETWORK ENVIRONMENT

(71) Applicant: ELECTRONICS AND TELECOMMUNICATIONS RESEARCH INSTITUTE, Daejeon (KR)

(72) Inventors: Min-Suk CHOI, Daejeon (KR); Jae-Deok LIM, Sejong-si (KR)

(73) Assignee: ELECTRONICS AND TELECOMMUNICATIONS RESEARCH INSTITUTE, Daejeon (KR)

(21) Appl. No.: 18/817,904

(22) Filed: Aug. 28, 2024

(30) Foreign Application Priority Data
Mar. 7, 2024 (KR) 10-2024-0032344
May 3, 2024 (KR) 10-2024-0058997

(51) Int. Cl. H04W 52/02; H04W 72/23

(52) U.S. Cl. CPC H04W 52/0235; H04W 72/23

(57) ABSTRACT

Disclosed herein is an apparatus and method for monitoring radio resources in a multi-network environment. The apparatus receives a Low-Power Wake-Up Signal (LP-WUS) based on predefined configuration information within the coverage of multiple radio resources, wakes up a main radio corresponding to an available resource, among the multiple radio resources, based on the configuration information, and performs Physical Downlink Control Channel (PDCCH) monitoring using the woken up main radio.

### CROSS REFERENCE TO RELATED APPLICATIONS

This application claims the benefit of Korean Patent Applications No. 10-2024-0032344, filed Mar. 7, 2024, and No. 10-2024-0058997, filed May 3, 2024, which are hereby incorporated by reference in their entireties into this application.

### BACKGROUND OF THE INVENTION

### 1. Technical Field

The present disclosure relates generally to wireless network technology, and more particularly to technology for monitoring radio resources in a multi-network environment.

### 2. Description of the Related Art

In the Internet-of-Things (IoT) network environment, IoT devices powered by batteries with a finite lifespan are deployed and used in various parts of our lives. The characteristics of such IoT devices with a finite lifespan largely affect the deployment and the method of using the devices depending on the purpose of use. As such IoT devices have been recently rapidly increased, these are deployed and used in a various places, and costs for device maintenance and battery exchange and costs of batteries themselves are increasing.

In 5G networks, various Low Power Wide Area (LPWA) technologies, such as enhanced machine-type communication (eMTC), narrowband IoT (NB-IoT), Reduced Capability (RedCap), etc., have been developed to meet market's needs. These LPWA technologies achieved low cost, low power, and large-scale connectivity, and may meet the requirements of various applications. However, in extreme environmental conditions (high pressure, extremely high or low temperatures, humid environments, or mission-critical conditions (e.g., traffic, fire, medical care, etc.)), it is intended to improve network efficiency by focusing on low complexity, small sizes, reduced functions, and low power consumption, compared to IoT devices (e.g., NB-IoT/eMTC devices) covered by 3GPP.

In 3GPP, various researches for reducing power consumption of terminals have been conducted as a method for improving performance. Particularly, Discontinuous Reception (DRX) is technology that makes a terminal perform noncontinuous reception and thereby reduces as much power as consumed for a section (DRX cycle) during which the terminal does not receive data. DRX was defined in LTE release 8, and in release 13, extended DRX (eDRX), which is improved to have an increased cycle by extending the DRX cycle, was proposed and various other research items have also been proposed, studied, and developed. Although eDRX reduces power consumption by employing a longer DRX cycle than DRX, when IoT devices having critical functions, such as mission-critical functions, are operated in a network, the use of batteries having high efficiency is required, compared to the existing technologies, such as DRX/eDRX. There is a method of extending a cycle period of eDRX for energy reduction, but it increases a service delay time, so there is a limitation in selecting the method as an alternative of eDRX technology. Therefore, a more improved power reduction mechanism to be applied to IoT devices operated with ultra-low power is required.

A terminal in eDRX enters a power-saving mode (deep sleep, a low-power state) and wakes up once per eDRX cycle to process data that is generated during the power-saving time. This operation is applied in both an RRC_Idle state and an RRC_Connected state, and the methods of storing data are different depending on the RRC state, but the stored data is processed in the same manner. The eDRX cycle may be set to range from a few seconds to several hundred seconds. The longer the cycle, the higher the power efficiency, but the longer cycle is not suitable for low-latency service in terms of latency. Therefore, researches for supporting low latency while increasing power efficiency are required.

From 3GPP Rel-15, a paging signal (Wake Up Signal (WUS)) that is transmitted over a Physical Downlink Shared Channel (PDSCH) in order to wake up a terminal from a sleep state and make the terminal ready to transmit and receive data was first introduced, and particularly in Rel-16, various 5G standard technologies related to a WUS have been proposed in order to reduce power consumption. These technologies are named Low-Power WUS (LP-WUS), and items related thereto are being researched. In Rel-17, Paging Early Indication (PEI) technology has been proposed, and PEI is technology that reduces power consumption based on a concept in which a UE is notified in advance of whether it has to monitor a Paging Occasion (PO) thereof in order to monitor a WUS based on a connected Physical Downlink Control Channel (PDCCH) in the PO, so that the UE wakes up only when a PEI is received, and otherwise, it skips the PO. In the case of PEI, up to 8 subgroups per PO are introduced and indicated by bits in the Downlink Control Information (DCI) or reference signals.

LP-WUS is technology for providing ultra-deep sleep (an ultra-low power state) that provides an increased power-saving time compared to a deep sleep period, which is the power-saving time of a Main Radio (MR). This is technology that reduces power consumption by maximally delaying the time at which a main radio wakes up from a sleep state in order to monitor a PDCCH based on the scheduling information provided by a PDSCH.

However, when a terminal 100 suffers service disconnection from a 5G network due to a change in a radio environment or when the radio environment is deteriorated because the terminal 100 moves out of the coverage of a LP-WUR, it may be impossible to wake up a main radio through a LP-WUS.

Accordingly, a procedure for reselecting a cell due to the service disconnection between the terminal 100 and the 5G network may commence, or a follow-up procedure for monitoring a paging message by initiating a main radio after a wake up from dormancy may be performed as the result of radio deterioration, which results from moving out of the coverage of LP-WUR/WUS.

Such a follow-up procedure is suitable for resuming the service, but it increases the power consumption of the terminal 100, and service latency may increase because the time taken to perform the procedure increases service disconnection or delay time.

The above-described ultra-low power technology proposes the ultra-low power technology on the assumption that an IoT terminal enters network coverage in a single network. However, if various radio resources (a 5G network, an LTE network, a relay network, Integrated Access and Backhaul (IAB), etc.), which are available depending on the radio environment in which the terminal is located, are deployed, it should be possible for the terminal to be provided with service using all of the available resources.

Meanwhile, U.S. Patent Application Publication No. US2024-0015655, titled “Method and apparatus for low power wake-up signal transmission”, discloses various solutions for transmitting a low-power wake-up signal (LP-WUS) for user devices and network devices in mobile communication.

### SUMMARY OF THE INVENTION

An object of the present disclosure is to increase availability of radio resources, thereby providing service continuity such that a service can be smoothly used even in the event of unexpected service disconnection.

Another object of the present disclosure is to satisfy requirements for ultra-low power and low latency for IoT terminals operating in a multi-radio environment and to provide highly available technology compared to existing methods.

A further object of the present disclosure is to optimize an LP-WUR/WUS method for multiple networks, thereby achieving the lowest power consumption and low latency and improving availability.

In order to accomplish the above objects, an apparatus for monitoring radio resources in a multi-network environment according to an embodiment of the present disclosure includes one or more processors and memory in which at least one program executed by the one or more processors is stored. The at least one program receives a Low-Power Wake-Up Signal (LP-WUS) based on predefined configuration information within the coverage of multiple radio resources, wakes up a main radio corresponding to an available resource, among the multiple radio resources, based on the configuration information, and performs Physical Downlink Control Channel (PDCCH) monitoring using the woken up main radio.

Here, the configuration information may include information in which a priority order of the multiple radio resources is defined by a base station based on signal quality of the multiple radio resources.

Here, the at least one program may wake up a main radio corresponding to a radio resource having the second-highest priority based on the configuration information in the event of disconnection from a service of a radio resource having the highest priority.

Here, the at least one program may set a duty cycle ratio for a radio signal of an available radio resource based on the signal quality of the multiple radio resources.

Here, the configuration information may include information about a duty cycle period and a reception ratio between reception periods of main radios corresponding to the multiple radio resources, which are allocated by a base station depending on the signal quality of the multiple radio resources.

Here, the at least one program may receive the LP-WUS by performing WUS monitoring according to the reception periods of the main radios based on the configuration information.

Here, the at least one program may wake up a main radio corresponding to an available resource that receives the LP-WUS in the duty cycle period.

Here, the at least one program may perform PDCCH monitoring using the woken up main radio during active time corresponding to the duty cycle period.

Also, in order to accomplish the above objects, a method for monitoring radio resources in a multi-network environment, performed by an apparatus for monitoring radio resources in a multi-network environment, according to an embodiment of the present disclosure includes receiving a Low-Power Wake-Up Signal (LP-WUS) based on predefined configuration information within the coverage of multiple radio resources, waking up a main radio corresponding to an available resource, among the multiple radio resources, based on the configuration information, and performing Physical Downlink Control Channel (PDCCH) monitoring using the woken up main radio.

Here, the configuration information may include information in which a priority order of the multiple radio resources is defined by a base station based on signal quality of the multiple radio resources.

Here, waking up the main radio may comprise waking up a main radio corresponding to a radio resource having the second-highest priority based on the configuration information in the event of disconnection from a service of a radio resource having the highest priority.

Here, receiving the LP-WUS may comprise setting a duty cycle ratio for a radio signal of an available radio resource based on the signal quality of the multiple radio resources.

Here, the configuration information may include information about a duty cycle period and a reception ratio between reception periods of main radios corresponding to the multiple radio resources, which are allocated by a base station depending on the signal quality of the multiple radio resources.

Here, receiving the LP-WUS may comprise receiving the LP-WUS by performing WUS monitoring according to the reception periods of the main radios based on the configuration information.

Here, waking up the main radio may comprise waking up a main radio corresponding to an available resource that receives the LP-WUS in the duty cycle period.

Here, performing the PDCCH monitoring may comprise performing the PDCCH monitoring using the woken up main radio during active time corresponding to the duty cycle period.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating a scenario of DRX (eDRX) and LP-WUR/WUS operations of an IoT terminal according to an embodiment of the present disclosure;

FIG. 2 is a view illustrating a scenario in which an IoT terminal is disconnected from a service and moves out of coverage according to an embodiment of the present disclosure;

FIG. 3 is a flowchart illustrating a method for monitoring radio resources in a multi-network environment using an improved LP-WUS continuous technique according to an embodiment of the present disclosure;

FIG. 4 is a view illustrating an improved LP-WUS continuous technique according to an embodiment of the present disclosure;

FIG. 5 is a view illustrating a scenario about multiple available resources of an IoT terminal according to an embodiment of the present disclosure;

FIG. 6 is a flowchart illustrating a method for monitoring radio resources in a multi-network environment using an improved LP-WUS duty-cycled technique according to an embodiment of the present disclosure;

FIG. 7 is a view illustrating an improved LP-WUS duty-cycled technique according to an embodiment of the present disclosure;

FIG. 8 is a view illustrating an operation process of an improved LP-WUS duty-cycled technique in a multi-radio environment according to an embodiment of the present disclosure; and

FIG. 9 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

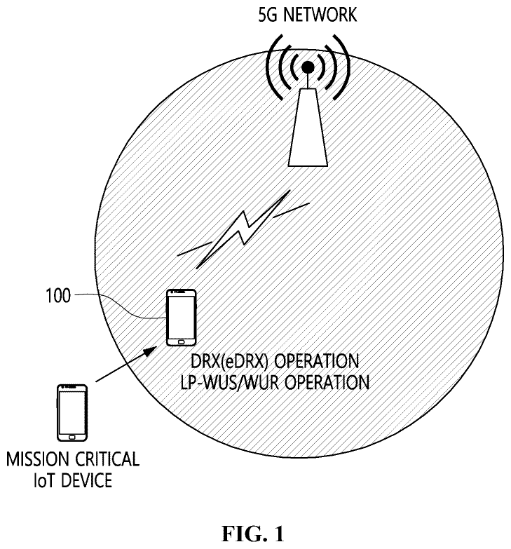

FIG. 1 is a view illustrating a scenario of DRX (eDRX) and LP-WUR/WUS operations of an IoT terminal according to an embodiment of the present disclosure.

Referring to FIG. 1, it can be seen that, when an IoT terminal 100 enters the LP-WUS coverage of a 5G network, the IoT terminal 100 performs DRX (eDRX) and LP-WUR/WUS operations.

The terminal 100 applying LP-WUR/WUS may include a Low-Power (LP) receiver for receiving an LP-WUS, separately from a receiver for a main radio.

The main radio of the terminal 100 may enter an ultra-deep sleep mode, and the LP receiver (LP-WUR) may perform monitoring for receiving an LP-WUS.

When the LP-WUR receives an LP-WUS, it may wake up the terminal 100 and wake up the main radio receiver from the ultra-deep sleep (UDS) mode after switching on the same, whereby PDCCH monitoring may be performed.

The LP-WUR/WUS operations of the terminal 100 may include a ‘duty-cycled’ mode and a ‘continuous’ mode, and the two modes may be operated according to different mechanisms.

Here, the terminal 100 may correspond to an apparatus for monitoring radio resources in a multi-network environment according to an embodiment of the present disclosure.

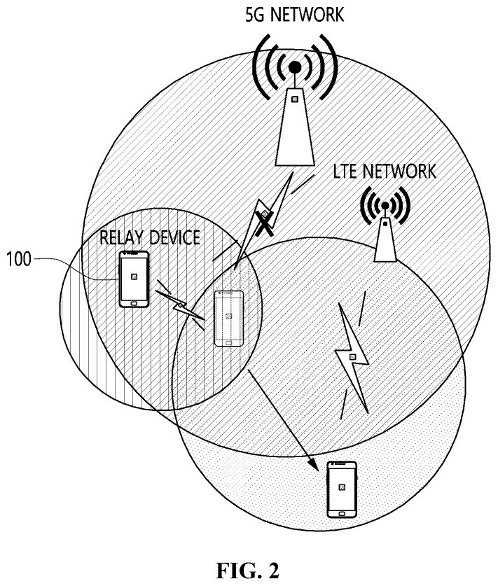

FIG. 2 is a view illustrating a scenario in which an IoT terminal is disconnected from a service and moves out of coverage according to an embodiment of the present disclosure.

Referring to FIG. 2, when a terminal 100 is within the coverage of various radio resources (5G, LTE, and a relay), an apparatus for monitoring radio resources in a multi-network environment according to an embodiment of the present disclosure may receive an LP-WUS based on configuration information transferred to the terminal 100 located within the coverage of the 5G network.

Here, in order to improve availability and minimize service delay and an increase in power consumption, which are caused due to unexpected service disconnection or the terminal 100 moving out of the coverage of the 5G network, the apparatus for monitoring radio resources in a multi-network environment may provide an improved LP-WUR/WUS method for using the available resources (the LTE network, the relay, etc.).

Here, the apparatus for monitoring radio resources in a multi-network environment may wake up a main radio having high priority, among the available resources, according to a priority policy.

In the environment in which various radio resources, such as 5G, LTE, and a relay, are available, DRX (eDRX) of all of the resources may operate according to a mechanism using the same cycle.

Also, configuration information for the LP-WUR/WUS operations may be transferred through System Information (SI) or Radio Resource Control (RRC) Release.

In the state in which the terminal 100 is within the coverage of all of the radio resources as shown in FIG. 2, when an LP-WUS is received based on the configuration information transferred to the terminal, a wake up of a main radio having high priority, among the available resources, may be performed according to a priority policy.

Information about resources that are currently available by the terminal 100 may be collected through measurement, and a priority order may be defined by a base station based on signal quality, such as Reference Signals Received Power (RSRP) and Reference Signal Received Quality (RSRQ), and transmitted to the terminal 100 through SI (System information Block (SIB)).

Based on the received SI information, the terminal 100 may perform a wake up of the main radio of the resource having high priority through an LP-WUR.

Although the terminal 100 is disconnected from the service of the current network in use or moves out of the LP-WUR/WUS coverage of the current network in use, when it is within the coverage of other available networks (one or multiple networks), LP-WUS monitoring may be performed through the LP-WUR/WUS procedure of the network having the second-highest priority.

Accordingly, the main radio may remain in the inactive state, and because the LP-WUR/WUS operation may be performed without performing a procedure of accessing a new network, power consumption may be reduced and a service having low latency and high availability may be provided.

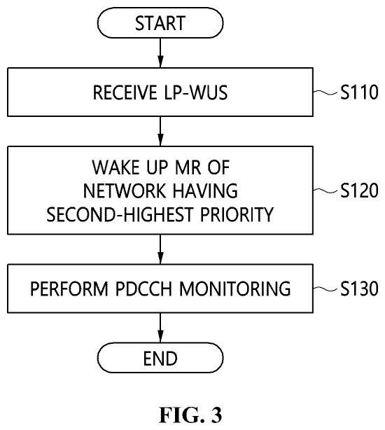

FIG. 3 is a flowchart illustrating a method for monitoring radio resources in a multi-network environment using an improved LP-WUS continuous technique according to an embodiment of the present disclosure.

Referring to FIG. 3, in the method for monitoring radio resources in a multi-network environment, first, a Low-Power Wake Up Signal (LP-WUS) may be received at step S110.

That is, at step S110, a terminal 100 within the coverage of a Low-Power Wake Up Signal (LP-WUS) of various radio resources (5G, LTE, and a relay) may receive an LP-WUS.

Here, at step S110, the terminal 100 may receive an LP-WUS based on predefined configuration information.

Here, the configuration information for an LP-WUR/WUS operation may be transferred through SI or RRC Release.

Here, the configuration information may include information in which the priority order of the multiple radio resources is defined by a base station based on the signal quality of the multiple radio resources.

Also, in the method for monitoring radio resources in a multi-network environment, the main radio of a network having the second-highest priority may be woken up at step S120.

That is, at step S120, when disconnection from the service of the radio resource having the highest priority occurs, the main radio corresponding to the radio resource having the second-highest priority may be woken up based on the configuration information.

Here, at step S120, in the event of moving out of the coverage of the radio resource corresponding to the current location, the main radio having high priority, among available radio resources, may be woken up according to a priority policy.

Here, synchronization for the LP-WUR/WUS function may be performed first for the available radio resources.

Also, in the method for monitoring radio resources in a multi-network environment, PDCCH monitoring may be performed using the woken up main radio at S130.

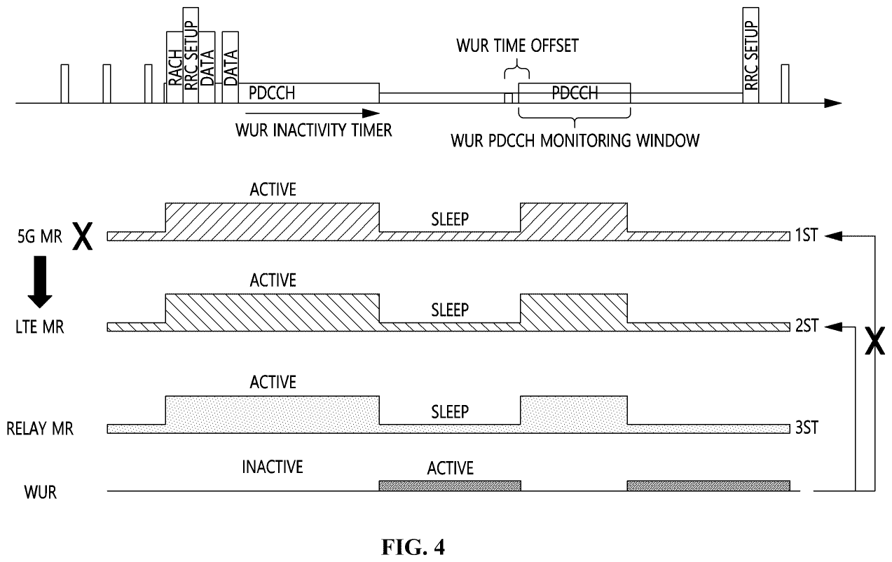

FIG. 4 is a view illustrating an improved LP-WUS continuous technique according to an embodiment of the present disclosure.

Referring to FIG. 4, when disconnection from the service of a 5G network occurs or when an IoT terminal moves out of the coverage of the 5G network, the terminal 100 remains in a UDS state, rather than waking up from a sleep mode, thereby reducing power consumption.

Because disconnection from the service of the 5G network is assumed, a WUR may operate in order to wake up an LTE network, not the 5G network, may wake up from a sleep mode in order to wake up an LTE main radio when a service occurs, may wake up the LTE main radio of the LTE network, and may perform PDCCH monitoring.

The terminal 100 may reduce power consumption by continuously remaining in the sleep mode before a service occurs, and may provide continuous service by selecting another available radio resource.

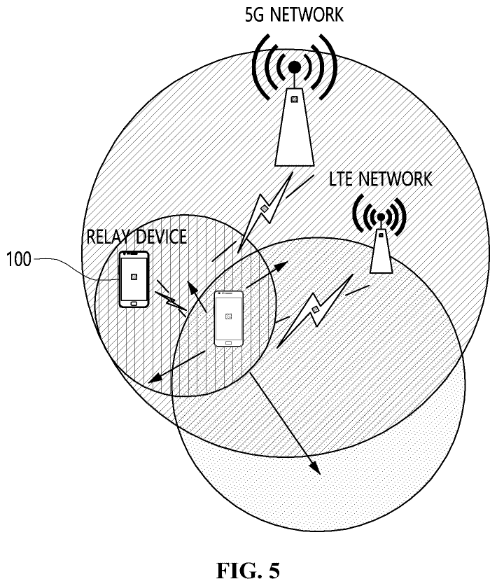

FIG. 5 is a view illustrating a scenario about multiple available resources of an IoT terminal according to an embodiment of the present disclosure.

Referring to FIG. 5, a state in which an IoT terminal in a sleep mode is present in an environment including various radio resources or moves therein, so one or more radio resources are available is illustrated. Here, the terminal may be provided with the best service quality by selecting a resource having the best quality and short latency from among the available radio resources.

When various radio resources (5G, LTE, and a relay) are mixed, selecting and using only one resource may decrease availability.

Therefore, when the terminal 100 uses a service by selecting the resource having the best quality and low latency, availability and the quality of service may be improved.

Here, even when the terminal 100 is in a sleep state, it is most desirable to select the radio resource having the best quality and to use the selected radio resource when it wakes up from the sleep mode.

A duty-cycle WUR operation may be performed in such a way that, when the main radio of the terminal 100 is in a sleep state during a UDS period, a WUR performs LP monitoring in an active state in order to receive a WUS.

Here, the terminal 100 is active only during the duty-cycle time and monitors a WUS.

Here, when a WUS is received, the terminal 100 may wake up the main radio corresponding to the available resource receiving the WUS from the UDS state and perform monitoring for a paging signal.

When the main radio is in a sleep state during the UDS period, the WUR may perform LP monitoring in the active state in order to receive a WUS.

Here, in the case of an IoT terminal operated in a radio environment in which a critical function is performed, such as an active mission-critical environment, availability is also an important issue along with the necessity of the low-power mechanism in which the entire sleep time of the main radio is taken into account.

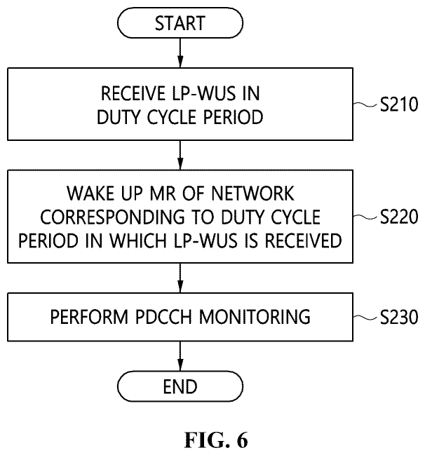

FIG. 6 is a flowchart illustrating a method for monitoring radio resources in a multi-network environment using an improved LP-WUS duty-cycled technique according to an embodiment of the present disclosure.

Referring to FIG. 6, in the method for monitoring radio resources in a multi-network environment, first, a Low-Power Wake Up Signal (LP-WUS) may be received at step S210.

That is, at step S210, a terminal 100 within the coverage of a Low-Power Wake Up Signal (LP-WUS) of various radio resources (5G, LTE, and a relay) may receive an LP-WUS based on predefined configuration information.

Here, at step S210, a duty cycle value set depending a preset ratio may be received through the configuration information (SI).

Here, at step $210, a duty cycle ratio for a radio signal of an available radio resource may be set based on the signal quality of the multiple radio resources.

Here, the configuration information may include information about a duty cycle period and a reception ratio between the reception periods of main radios corresponding to the multiple radio resources, which are allocated by a base station depending on the signal quality of the multiple radio resources.

Here, at step S210, WUS monitoring is performed according to the reception periods of the main radios based on the configuration information, whereby the LP-WUS may be received.

Here, at step S210, the WUS may be monitored based on the configuration information, and the WUS may be received in the duty cycle period of one of 5G, LTE, and a relay.

Here, the configuration information for the LP-WUR/WUS operation may be transferred through SI or RRC Release.

Also, in the method for monitoring radio resources in a multi-network environment, a main radio of the network corresponding to the duty cycle period in which the WUS is received may be woken up at S220.

That is, at step S220, the main radio corresponding to the available resource that receives the LP-WUS in the duty cycle period may be woken up.

Here, synchronization for the LP-WUR/WUS function may be performed first for the available radio resource.

Also, in the method for monitoring radio resources in a multi-network environment, PDCCH monitoring may be performed using the woken up main radio at step S230.

That is, at step S230, PDCCH monitoring may be performed using the woken up main radio during the active time corresponding to the duty cycle period.

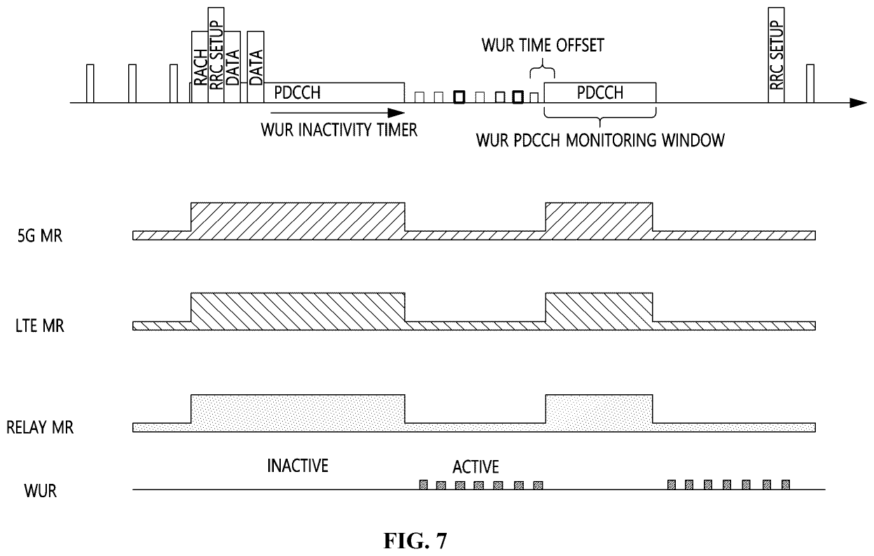

FIG. 7 is a view illustrating an improved LP-WUS duty-cycled technique according to an embodiment of the present disclosure.

Referring to FIG. 7, it can be seen that, when a terminal is in a sleep mode in an environment in which various radio resources are mixed, an improved LP-WUS duty-cycled technique for all available resources is illustrated.

The terminal 100 is able to use 5G, LTE, and relay radio resources, and all of these resources maintain DRX (eDRX) of the same cycle.

Here, the terminal 100 may adjust the duty cycle ratio for available radio resources based on the signal quality, such as RSRQ, RSRP, etc., acquired based on measurement.

The terminal 100 may receive a duty cycle value set depending on a preset ratio through configuration information (SI).

Here, the terminal 100 may monitor a WUS based on the configuration information and receive the WUS in the duty cycle period of one of 5G, LTE, and a relay.

Here, the terminal 100 may wake up the main radio of the resource corresponding to the WUS and perform PDCCH monitoring.

The WUS is received in the duty cycle period corresponding to 5G, whereby the terminal may perform a wake up from a UDS mode.

Here, the terminal 100 may wake up the 5G main radio.

Here, the terminal 100 may perform PDCCH monitoring using the 5G main radio.

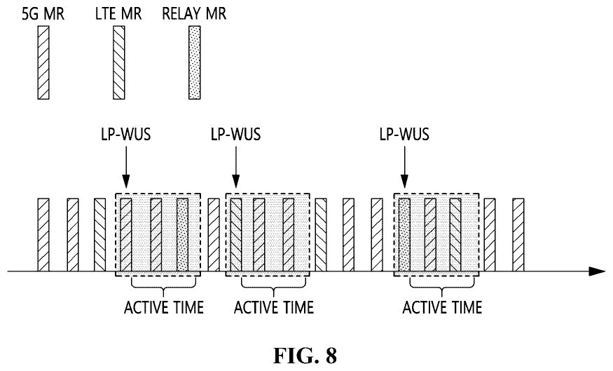

FIG. 8 is a view illustrating an operation process of an improved LP-WUS duty-cycled technique in a multi-radio environment according to an embodiment of the present disclosure.

Referring to FIG. 8, it can be seen that a WUR operates according to the duty cycle periods of 5G, LTE, and relay radio resources as an example of an improved LP-WUS duty-cycled method.

In order to use any of various resources depending on the situation, the apparatus for monitoring radio resources in a multi-network environment may receive a WUS by setting duty cycles for all available resources.

The apparatus for monitoring radio resource in a multi-network environment may wake up the main radio of an available resource corresponding to a duty cycle period and monitor a PDCCH.

The duty cycle ratio of the LP-WUS duty-cycled technique and the ratio between the reception periods of the main radios corresponding to the radio resources may be arbitrarily allocated by a base station depending on the signal quality of the multiple radio resources.

When the terminal 100 wakes up, the base station may provide the most optimized duty cycle period and the ratio between the reception periods of the main radios corresponding to the radio resources in real time through SI information.

The first LP-WUS is transmitted in the 5G WUR period, whereby the 5G main radio may be woken up and PDCCH monitoring may be performed during the active time.

The second LP-WUS is transmitted in the LTE main radio period, whereby the LTE main radio may be woken up and PDCCH monitoring may be performed during the active time.

The third LP-WUS is transmitted in the relay main radio period, whereby the relay main radio may be woken up and PDCCH monitoring may be performed during the active time.

Here, the apparatus for monitoring radio resources in a multi-network environment may provide high-quality service by setting the resource having the best quality, among the various radio resources, to have the most frequent period.

Here, the apparatus for monitoring radio resources in a multi-network environment sets the period depending on the characteristics of the available radio resource to compensate for disconnection from the services of other resources, thereby increasing availability and providing service continuity.

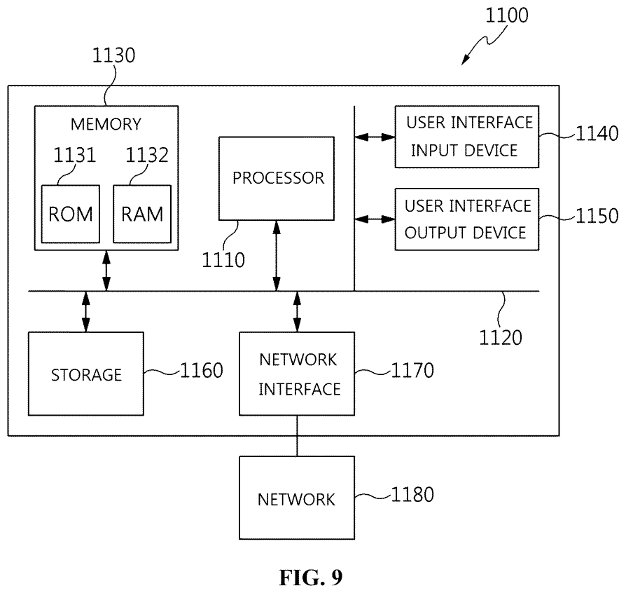

FIG. 9 is a view illustrating a computer system according to an embodiment of the present disclosure.

Referring to FIG. 9, the apparatus for monitoring radio resources in a multi-network environment and the terminal 100 according to an embodiment of the present disclosure may be implemented in a computer system 1100 including a computer-readable recording medium. As illustrated in FIG. 9, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for monitoring radio resources in a multi-network environment according to an embodiment of the present disclosure includes one or more processors 1110 and memory 1130 in which at least one program executed by the one or more processors 1110 is stored. The at least one program receives a Low-Power Wake-Up Signal (LP-WUS) based on predefined configuration information within the coverage of multiple radio resources, wakes up a main radio corresponding to an available resource, among the multiple radio resources, based on the configuration information, and performs Physical Downlink Control Channel (PDCCH) monitoring using the woken up main radio.

Here, the configuration information may include information in which the priority order of the multiple radio resources is defined by a base station based on the signal quality of the multiple radio resources.

Here, the at least one program may wake up a main radio corresponding to a radio resource having the second-highest priority based on the configuration information in the event of disconnection from a service of a radio resource having the highest priority.

Here, the at least one programs may set a duty cycle ratio for a radio signal of an available radio resource based on the signal quality of the multiple radio resources.

Here, the configuration information may include information about a duty cycle period and a reception ratio between the reception periods of the main radios corresponding to the multiple radio resources, which are allocated by the base station depending on the signal quality of the multiple radio resources.

Here, the at least one program may receive the LP-WUS by performing WUS monitoring according to the reception periods of the main radios based on the configuration information.

Here, the at least one program may wake up the main radio corresponding to the available resource that receives the LP-WUS in the duty cycle period.

Here, the at least one program may perform PDCCH monitoring using the woken up main radio during the active time corresponding to the duty cycle period.

The present disclosure increases availability of radio resources, thereby providing service continuity such that a service can be smoothly used even in the event of unexpected service disconnection.

Also, the present disclosure may satisfy requirements for ultra-low power and low latency for IoT terminals operating in a multi-radio environment and provide highly available technology compared to existing methods.

Also, the present disclosure may achieve the lowest power consumption and low latency and improve availability by optimizing an LP-WUR/WUS method for multiple networks.

As described above, the apparatus and method for monitoring radio resources in a multi-network environment according to the present disclosure is not limitedly applied to the configurations and operations of the above-described embodiments, but all or some of the embodiments may be selectively combined and configured, so the embodiments may be modified in various ways.

What is claimed is:

1. An apparatus for monitoring radio resources in a multi-network environment, comprising:
one or more processors; and
memory in which at least one program executed by the one or more processors is stored,
wherein the at least one program
receives a Low-Power Wake-up Signal (LP-WUS) based on predefined configuration information within coverage of multiple radio resources,
wakes up a main radio corresponding to an available resource, among the multiple radio resources, based on the configuration information, and
performs Physical Downlink Control Channel (PDCCH) monitoring using the woken up main radio.

2. The apparatus of claim 1, wherein the configuration information includes information in which a priority order of the multiple radio resources is defined by a base station based on signal quality of the multiple radio resources.

3. The apparatus of claim 2, wherein the at least one program wakes up a main radio corresponding to a radio resource having a second-highest priority based on the configuration information in an event of disconnection from a service of a radio resource having a highest priority.

4. The apparatus of claim 1, wherein the at least one program sets a duty cycle ratio for a radio signal of an available radio resource based on signal quality of the multiple radio resources.

5. The apparatus of claim 4, wherein the configuration information includes information about a duty cycle period and a reception ratio between reception periods of main radios corresponding to the multiple radio resources, which are allocated by a base station depending on the signal quality of the multiple radio resources.

6. The apparatus of claim 5, wherein the at least one program receives the LP- WUS by performing WUS monitoring according to the reception periods of the main radios based on the configuration information.

7. The apparatus of claim 6, wherein the at least one program wakes up a main radio corresponding to an available resource that receives the LP-WUS in the duty cycle period.

8. The apparatus of claim 7, wherein the at least one program performs PDCCH monitoring using the woken up main radio during active time corresponding to the duty cycle period.

9. A method for monitoring radio resources in a multi-network environment, performed by an apparatus for monitoring radio resources in a multi-network environment, comprising:
receiving a Low-Power Wake-up Signal (LP-WUS) based on predefined configuration information within coverage of multiple radio resources;
waking up a main radio corresponding to an available resource, among the multiple radio resources, based on the configuration information; and
performing Physical Downlink Control Channel (PDCCH) monitoring using the woken up main radio.

10. The method of claim 9, wherein the configuration information includes information in which a priority order of the multiple radio resources is defined by a base station based on signal quality of the multiple radio resources.

11. The method of claim 10, wherein waking up the main radio comprises waking up a main radio corresponding to a radio resource having a second-highest priority based on the configuration information in an event of disconnection from a service of a radio resource having a highest priority.

12. The method of claim 9, wherein receiving the LP-WUS comprises setting a duty cycle ratio for a radio signal of an available radio resource based on signal quality of the multiple radio resources.

13. The method of claim 12, wherein the configuration information includes information about a duty cycle period and a reception ratio between reception periods of main radios corresponding to the multiple radio resources, which are allocated by a base station depending on the signal quality of the multiple radio resources.

14. The method of claim 13, wherein receiving the LP-WUS comprises receiving the LP-WUS by performing WUS monitoring according to the reception periods of the main radios based on the configuration information.

15. The method of claim 14, wherein waking up the main radio comprises waking up a main radio corresponding to an available resource that receives the LP-WUS in the duty cycle period.

16. The method of claim 15, wherein performing the PDCCH monitoring comprises performing the PDCCH monitoring using the woken up main radio during active time corresponding to the duty cycle period.
